(19) United States
(12) Patent Application Publication
(10) Pub. No.: US 2013/0039611 A1
(43) Pub. Date: Feb. 14, 2013

(54) SEALING ASSEMBLY FOR A ROLLING BEARING

(71) Applicants: Erich Russ, Gremsdorf (DE); Hubertus Frank, Hochstadt (DE)

(72) Inventors: Erich Russ, Gremsdorf (DE); Hubertus Frank, Hochstadt (DE)

(73) Assignee: IMO HOLDING GMBH, Gremsdorf (DE)

(21) Appl. No.: 13/642,991

(22) PCT Filed: Apr. 26, 2011
(86) PCT No.: PCT/EP11/02077

§ 371 Date: Oct. 23, 2012

(30) Foreign Application Priority Data
Apr. 23, 2010 (DE) 10-2010-018-255.9

(51) Int. Cl. F16C 33/78

(52) U.S. Cl. 384/486

(57) ABSTRACT

The invention relates to a sealing assembly for a rolling bearing having two mutually concentric rings spaced apart from each other by a fully circumferential gap in which one or more rows of revolving rolling elements are disposed, such that the two rings are rotatable relative to each other about their common axis, wherein the gap is sealed in the region of at least one of its two mouths, and wherein provided in the region of a gap seal are at least two seal rings, each having at least one sealing lip and an anchoring region on a surface region of the particular seal ring that faces away from the sealing lip, the seal rings being fixed to the same rolling bearing ring, whereas their respective sealing lips bear against the other rolling bearing ring, specifically against surface regions having identical or similar cross section.

### BACKGROUND OF THE INVENTION

1. Field of the Invention

The invention relates to a sealing assembly for a rotary joint, particularly for a rolling bearing comprising two mutually concentric rings spaced apart from each other by a circumferential gap in which one or more rows of revolving rolling elements are disposed, such that the two rings are rotatable relative to each other about their common axis, and wherein the gap is sealed in the region of at least one of its two mouths.

2. Description of the Prior Art

The field of application for rotary joints in general, and for rolling bearings in particular, is boundless. Rotary joints of the type of the invention, particularly rolling bearings, are commonly lubricated with grease, less often with oil. The lubricant is retained in the region of the (rolling) bearing by seals, preferably disposed on both sides. The seals are frequently in the form of individual shaft seal rings, which are fixed with additional retaining rings, or are pressed directly together with the adjacent structure by means of the fastening screws.

In wind power installations, in particular, bearings of this kind are used increasingly as rotor bearings. This design is often preferred especially in gearless wind power installations, since it is economical and space-saving.

Due to the compact construction of wind power installations, it is not always possible to replace these seal rings once they are installed. To effect a replacement, it is often necessary to dismantle the generator or the hub, with the blades. The associated disassembly and downtime costs are extremely high. Costs are likely to be especially high for wind power installations situated in hard-to-access areas or actually offshore, i.e., out on the ocean far from the coast, where specialized vessels are needed for such work.

In addition, this often very poor accessibility makes it difficult to estimate and evaluate the condition of a seal. Since a rotor bearing of this kind, which can easily weigh several tons, still is, or will be, connected to the generator, and perhaps to other parts of the adjacent structure, the possibility cannot always be ruled out that dirt may get into the vicinity of the seal, for example, in the course of installation, maintenance or repair work, with consequent damage to the sealing lip and thus impairment of the overall sealing effect.

The disadvantages of the prior art give rise to the problem initiating the invention, that of improving a sealing assembly of the aforesaid kind in such a way that the sealing effect is optimal, insofar as possible, the most important point being to ensure higher reliability even under challenging environmental conditions. In addition, maintenance should be made easier, and, where practicable, it should also be possible to replace a seal of this kind without having to remove the particular bearing or parts thereof.

### SUMMARY OF THE INVENTION

This problem is solved by the fact that provided in the region of a gap seal are at least two spaced-apart seal rings, each having at least one sealing lip and an anchoring portion on a surface region of the particular seal ring that faces away from the sealing lip, wherein the seal rings are fixed by their anchoring portions to a common portion of the same rolling bearing ring, whereas their respective sealing lips bear against the other rolling bearing ring, specifically against thrust surfaces produced together with at least one raceway of the particular rolling bearing ring by machining or shaping a common base body, wherein the cross-sectional shapes of the thrust surfaces for the sealing lips of adjacent seal rings are identical, or similar, and are not separated from each other by either a bend or a step.

By virtue of the mutually corresponding surface regions, a plurality of such seal rings can be used and can be installed and even replaced, if necessary, in a simple manner. This is because the seal ring, disposed deeper inside the bearing gap, can readily be pushed away over the thrust surface of the outer seal ring without any risk of damage. In this context, the phrase “similar cross sections” is intended to refer to the basic geometry of the particular thrust surface, i.e., either both thrust surfaces are cylindrical or hollow-cylindrical, or they are both conical or planar. Irrespective of this overall geometry, a curvature can still be present transverse to the particular thrust surface; but this will be described in more detail later on below. The fact that the cross-sectional shapes of the thrust surfaces for the sealing lips of adjacent seal rings are not separated from each other by a bend or a step makes it much easier to put in place, or insert, one or both seal rings. A rolling bearing sealed according to the invention can even be operated in the open air without additional jacketing and will still always be protected adequately against inclement weather.

Particular advantages are provided by a design improvement according to which the anchoring regions of two adjacent seal rings are received in a common depression of a rolling bearing ring, particularly in a common recess or groove. Such a common depression is easier to produce than several mutually separate grooves; the seal rings can also be inserted in it more easily.

In this connection, the assembly can be configured such that a receiving portion that is part of a rolling bearing ring and contains the common depression, particularly recess or groove, is detachable from the main portion of the particular bearing ring. This has the particular advantage that to release a seal ring, a bearing portion at least locally surrounding it is first removed to make the seal itself easier to access. Such a detachable portion of a bearing ring can optionally be configured as one-piece, that is, as a closed, i.e. double-connected, ring, which can be pulled off or at least displaced, only in the axial direction in order to get at the seals, or it can be a part composed of plural segments, of which none of the individual segments completely surrounds the axis of rotation. In such case, these segments can not only be displaced in the axial direction but can also be moved in the radial direction, for example removed completely, without any need to dismantle the bearing ring concerned. In both embodiments, a specialized geometry can be provided in the region of the parting joint between the main portion of the particular bearing ring and the portion detachable from it, to automatically center the detachable portion as it is being mounted. This can be for example, a fully circumferential step or recess on one portion, the mating counterpart being formed on the respective other portion.

It is within the scope of the invention that the common depression, particularly groove or recess, is disposed on an annular receiving portion which itself has no raceway of any kind, but is fixed to an annular main portion of the particular rolling bearing ring that does have at least one raceway, produced by machining or shaping a common base body. This affords the possibility of gaining access to the seal rings concerned without having to expose the rolling elements.

The invention affords the further possibility that the receiving portion detachable from the main portion of a rolling bearing ring consists of a different or a differently treated, material from the main portion of that rolling bearing ring. It should be kept in mind, here, that to provide adequate service life, the main portion of the particular ring, comprising the bearing raceways, is preferably made from an expensive, particularly hard, or at least hardenable, bearing material, for example, a special steel. Such a requirement normally does not apply to the detachable ring portion, which only has to hold the seal rings. Consequently, to reduce the cost of such a rotary joint, another material can be used for this purpose, for example, brass, and/or in any case the material concerned is not put through a hardening step, as in the case of unhardened steel.

The invention recommends that the receiving portion detachable from the main portion of a rolling bearing ring has an approximately L-shaped cross section, whose end face facing toward the rolling elements is smaller in area than its end face facing away from the rolling elements. A ring with an L-shaped geometry makes it possible not only to center the particular seal rings in the radial direction, but also simultaneously to clamp them in place in the axial direction. Easy release is made possible by the fact that the end face, that is smaller in area, is facing toward the rolling elements and can thus be pulled off over the seal rings, if necessary.

The invention can be improved in that the receiving portion detachable from the main portion of a rolling bearing ring has, in the region of its end face facing away from the rolling elements, a circular-disk-shaped portion that overlaps the end face of one seal ring. This larger end face of the cross-sectionally L-shaped receiving ring has the function of pressing the overlapped seal ring and additional seal rings immediately adjacent thereto firmly against a portion of the end face of the rolling bearing ring comprising the raceways for the rolling elements.

The anchoring regions of two adjacent seal rings should be spatially separated from each other, so that the chamber between them has the greatest possible volume and can therefore provide sufficient receiving space for any leaking lubricant before it reaches the outer seal ring.

The feature just described can be realized in a particularly simple manner by separating the anchoring regions of two adjacent seal rings from each other by one or more spacers disposed between them. Such spacers make for particularly stable positioning of the seal rings they separate, and can also absorb axial pressure, so the anchoring regions of the seal rings can be additionally clamped in place.

Although the spacers can also be connected to the particular bearing ring, i.e., for example, in the form of bars protruding from the surface regions concerned, it is nevertheless provided, in continuation of the above inventive idea, that at least one spacer is configured as a ring or ring segment. These are detachable parts that can be replaced as necessary, or even exchanged, for parts having another geometry, in the event that sealing rings of another geometry are to be used for the adjacent seals. In particular, ring segments can also subsequently be inserted in groove-shaped depressions in concave surface regions of a bearing ring.

It is further provided that the sealing lips of adjacent seal rings bear against the same rolling bearing ring in spaced relation. Their distance apart is preferably constant along the entire circumference. If a seal ring extends along a plane that is intersected perpendicularly by the axis of rotation of the particular rotary joint, the sealing lip slides only in its longitudinal direction along the particular thrust surface, thus keeping friction to a minimum. In such case, the distance between two adjacent sealing lips should also be measured parallel to the axis of rotation of the particular rotary joint. This distance between the two sealing lips results in the creation of a chamber between the two sealing rings. This chamber serves to receive whatever quantity of lubricant has escaped the inner seal ring. Since any such leakage from the inner seal ring takes place relatively slowly if at all, the chamber fills with lubricant only gradually, and the outer seal ring can therefore retain the lubricant completely for a relatively long period of time.

The invention can be further improved in that between two seal rings, at least one conduit, preferably a bore, opens into the common depression or between the two thrust surface regions for the sealing lips of adjacent seal rings. In such case, this conduit can, for example, be used to check the fill level of the chamber between the two seal rings to determine whether any action is needed, for example, the addition of more lubricant or replacement of the seal. In addition, the possibility also exists—specifically in the case of oil as the lubricant—of using such a conduit to recycle lubricant that has found its way from the inner seal ring back into the gap region, such recycling, for example, taking place automatically under the force of gravity or being performed manually as a maintenance procedure. So that the lubricant cannot, conversely, make its way back through this conduit from the interior of the gap past the inner seal and into the chamber, such a conduit (or each such conduit) can be fitted with a check valve that permits flow only in the direction from the chamber between two seal rings to the interior of the gap, and blocks flow under reverse pressure conditions.

Two adjacent seal rings should both be integrated in such a way that an internal overpressure from the middle of the gap toward its mouth presses the sealing lip additionally against its thrust surface. Such a measure permits and assists the complete filling of the bearing gap with lubricant, an operation that might occasionally give rise to a local overpressure; this does not result in leakage, however, but presses the sealing lip particularly firmly against the thrust surface until the local overpressure has declined due to internal compensatory movement of the lubricant.

A preferred embodiment of the invention is distinguished by the fact that the rear anchoring region of a seal ring is substantially thicker in a direction running parallel to the cross section of the thrust surface than the portion of the seal ring adjacent the sealing lip. The function of such a thickened anchoring region is to give the seal ring adequate stability, whereas the front sealing lip is particularly elastic so that it is always able to conform to the thrust surface even if the bearing deforms severely, for example under the influence of external forces and/or moments, particularly tilting moments.

This purpose is also served by an improvement according to which the sealing lip of a seal ring is disposed at the free edge of an approximately collar-like, preferably conical, portion of the seal ring. This collar-like portion preferably has a smaller thickness and thus a higher elasticity than the thickened anchoring region and thus enables the sealing lip to move—within certain limits—relative to the anchoring region.

A seal ring according to the invention can be integrated in such a way that the collar-like portion of the seal ring does not extend, in cross section, perpendicular to the particular thrust surface, but rather in closer proximity to the outer, unsealed region of the thrust surface. This results in a cross-sectional shape, particularly on the respective inner face of the sealing ring—i.e., the surface facing the interior of the particular gap—which is parallel, or at least approximately parallel, to the particular thrust surface, and which can absorb the internal lubricant pressure and thereby presses the particular sealing collar, including the sealing lip located thereon, against the particular thrust surface.

The collar-like portion of a seal ring is preferably connected to its anchoring portion, specifically in that region of the end face of the anchoring portion which is located outside the sealed gap region. This one-piece embodiment is geometrically optimized and combines utmost stability with optimal sealing action.

It is, further, within the scope of the invention that at least one seal ring comprises a tensioning means, for example, a fully circumferential tension wire, to press the particular sealing lip firmly against the particular thrust surface. In this way, the contact pressure of a sealing lip against its thrust surface can be further increased, in order to enhance the sealing action still more where necessary. Such a tension wire can, for example, be coiled into a helical spring that passes once around the particular seal ring.

Such a fully circumferential tension spring should have a length that is equal to, or greater than, the diameter of a rolling element, multiplied by the number of rolling elements in the row concerned. Such dimensioning ensures that the tension spring produces the highest possible pressing force without being overstretched, instead remaining within the elastic deflection range.

It has proven beneficial for two adjacent seal rings to have the same cross-sectional structure. The seal rings used could—despite their identical structure—still have different cross-sectional dimensions or dimensional ratios. It is nevertheless recommended that two adjacent seal rings be identical. If an optimal cross-sectional geometry is found, then it can be used for both or all of the seal rings.

It is within the scope of the invention that the cross-sectional shapes of the thrust surfaces for the sealing lips of adjacent seal rings have mutually corresponding transverse curvatures, i.e., that they each have a concave transverse curvature or a convex transverse curvature, or that they each have a flat, i.e. planar, transverse profile with no transverse curvature whatsoever. Such an at least structurally identical transverse curvature—even if the radius of transverse curvature changes—also facilitates the insertion of the seal rings.

Further advantages are obtained if the cross-sectional shapes of the thrust surfaces for the sealing lips of adjacent seal rings have the same axial inclination, particularly are in mutual axial alignment. This feature is also intended to make the handling of the seal ring(s) as problem-free as possible.

Since the sealing lips of two adjacent seal rings bear or thrust against a common cylindrical surface region having a constant diameter, the seal rings need not be stretched or otherwise deformed during insertion and thus are not at risk of being damaged.

Finally, it is within the teaching of the invention that an outer seal is provided with a dust lip. The risk of ingress of dust or other particles can be effectively countered in this way. The element in question can be an additional seal ring, which may have a different cross section from the other seal rings of the particular gap seal.

Additional features, details, advantages and effects based on the invention will emerge from the following description of a preferred embodiment of the invention and by reference to the drawings.

### BRIEF DESCRIPTION OF THE DRAWINGS

FIG. 1 is a section through the a rolling bearing provided with a seal according to the invention; and

FIG. 2 is an enlargement of detail II of FIG. 1.

### DESCRIPTION OF THE PREFERRED EMBODIMENTS

The drawings illustrate an example of a preferred embodiment of the sealing principle according to the invention. It depicts a rolling bearing 1 that is preferably intended for use in a wind power installation, particularly as a rotor bearing or main bearing.

Apparent in the drawing are two mutually concentric bearing rings, an inner ring 2 of planar, circular shape and, engaged around the outside thereof, an outer ring 3 of corresponding geometry. Each of the two rings 2, 3 preferably has planar end faces 4, 5, which can serve as connection surfaces for connection to a foundation or to an installation part or machine part. Provided for this purpose, in at least one end face 4, 5 per bearing ring 2, 3, is a plurality of coronally arranged fastening means, particularly fastening bores 6, whose longitudinal axes preferably extend perpendicularly to the respective end face 4, 5 and which are intended for machine screws, (threaded) bolts, or the like, to be passed through or screwed into them.

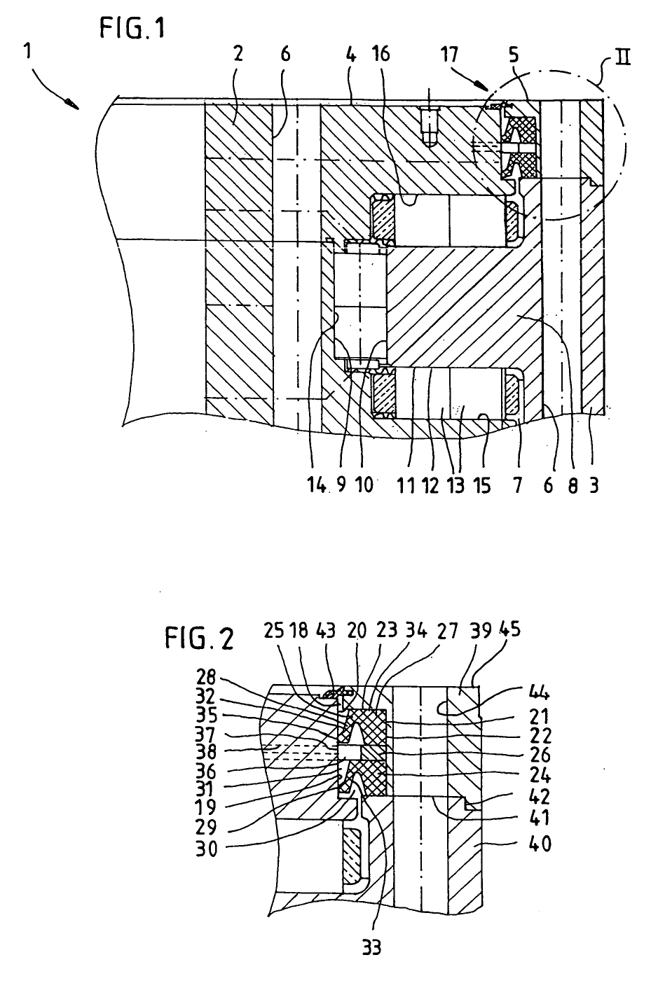

A gap 7 is present between the two bearing rings 2, 3, so that the rings 2, 3 can rotate relative to each other. However, as is apparent from FIG. 1, this gap does not have a rectilinear cross section, but a shape having a plurality of bends.

The reason for this is that a fully circumferential flange 8, preferably of approximately rectangular cross section, is disposed on the inner side of outer ring 3. In technical jargon, such a flange 8 is termed a nose, and the ring concerned—here, outer ring 3—is known as a nose ring.

At the same time, the other ring—here, inner ring 2—comprises a similarly shaped, fully circumferential depression 9 with a larger cross section than the flange 8 or nose, such that the latter can in large part be received by the fully circumferential depression 9.

At the edges in the region of the free end face 10 of the flange 8 or nose, as well as in the recesses at the base of the latter, the gap 7 bends approximately 90° in cross section in each case.

The free end face 10 of the flange 8, as well as its two flanks 11, each serve as raceways 12 for the roller-shaped rolling elements 13. The counterparts to these raceways 12 are disposed at the bottom 14 and at the two flanks 15 of the depression 9 of inner ring 2, in the form of raceways 16 there. These raceways are preferably hardened, preferably by surface hardening.

Such rollers 13 are able to absorb or transfer extremely high forces and tilting moments and achieve much higher values in this regard than balls, for example, since they form linear rather than punctiform contact regions with the raceways 12, 16. For them to roll freely, however, the rolling elements 13 must be well lubricated, preferably with grease; only in relatively rare cases is lubricating oil used for this purpose.

This lubricant must be durably retained in the region of the rolling elements 13, i.e., in the interior of the gap 7. This function is performed by seals 17 in the region of the two end-face mouths 18 of the gap 7. In the example illustrated, the same seals 17 are used at both mouths 18, so only one of the two need be described. The details of the seals 17 are shown enlarged in FIG. 2 and thus are easier to see in that drawing.

In a mouth portion 18 of the gap 7, the outer side 19 of the inner ring 2 follows a cylindrical shape. Opposite thereto, machined into the inner side 20 of the outer ring 3 is a groove-shaped depression 21, preferably having a hollow-cylindrical base 22 and two planar flanks 23, such that the cross section can be described by a rectangle.

Inserted in this depression 21 are two seal rings 24, 25 and an also ring-shaped spacer element 26, specifically one after the other in the axial direction parallel to the axis of rotation of the rolling bearing 1, the spacer element 26 being disposed between the two seal rings 24, 25.

As can be seen in FIG. 2, in the illustrated exemplary embodiment the two seal rings 24, 25 are identical. The two therefore have identical cross sections, each comprising three portions, specifically an anchoring portion 27, a collar-shaped portion 28 connected thereto and a sealing lip 29 extending along the free edge of the collar-shaped portion 28.

It will be appreciated that, as a result of this cross-sectional geometry, a ring with a rectangular cross section will be provided with two incuts that extend along the its entire length. A first incut 30 separates the anchoring portion 27, on the one side, from the collar-shaped portion 28 and the sealing lip 29, on the other side. This incut 30 has an approximately V-shaped cross section, with a depth that is only slightly smaller than the thickness, parallel to the bearing axis, of the particular seal ring 24, 25. Since the incut 30 is shifted toward the sealing lip 29, the anchoring portion 27 takes up roughly half the cross section of the originally rectangular ring cross section. Immediately adjacent incut 30—facing away from the anchoring portion 27—the collar-shaped portion 28 terminates in the sealing lip 29.

A second incut 31 is on the opposite surface of the collar-shaped portion 28. It has only about half the cross section of the first incut 30, and it follows approximately the geometry of a right triangle whose hypotenuse 32 is approximately parallel to the nearest flank 33 of the first, V-shaped incut 30. The distance between this hypotenuse 32 and the nearest flank 33 of the first, V-shaped incut 30 corresponds to the thickness of the collar-shaped sealing portion 28.

Both seal rings 24, 25 are placed in the depression 21 in such a way that the collar-shaped portions 28 are each joined, in the region of a peripheral end face 34 of the respective seal ring 24, 25, to the anchoring portion 27 thereof, while the collar-shaped regions 28 extend from there along an oblique line to the interior of the gap 7, thus the sealing lip 29 then sits, bearing against a cylindrical surface region 35 of the inner ring 2, which region serves as a thrust surface. Owing to the incut 30 that faces the gap interior 7 and widens in a V shape from the root of the collar-shaped region 28 near anchoring portion 27 on out to the sealing lip 29, an internal overpressure in the region of the gap interior 7 causes an increased pressure on the collar-shaped portion 28 in the region of the incut 30, thereby creating a force that presses the collar-shaped portion 28, and thus its sealing lip 29, toward the thrust surface 35, so hardly any lubricant is able to escape. This pressing force can be further increased by using a spring as, for example, a tension wire that runs along the side of the collar-shaped portion 28 facing away from the sealing lip 29 and is pretensioned.

Should this nevertheless occur, the lubricant will get no farther than a chamber 36 formed between surface region 35, on the one hand, and the two seal rings 24, 25 and spacer element 26, on the other. Spacer element 26 serves to enlarge the chamber 36. Either it can consist of a single piece having an annular geometry, which either can be configured as double-connected or could be configured with a slit after the fashion of a spring-lock washer, i.e., only single-connected, to make it easier to insert in, or remove from, the depression 21. Or the spacer element 26 consists of a plurality of parts that mate together into a ring shape, i.e., for example, a plurality of ring-segment-shaped parts. The spacer ring 26, as a whole, preferably has a rectangular cross section; its radial extent preferably corresponds approximately to the relevant dimension of the anchoring portion 27. The spacer element 26 is preferably pressed against the bottom of the depression 21, so that the collar-shaped region 28, and particularly the sealing lip 29, can move without being hindered by it.

If some of the lubricant manages to escape from the inner seal ring 24, it first passes into the region of the chamber 36 and can be received by it. Only when the chamber 36 is full does lubricant come to be present at the outer seal ring 25. There is, consequently, a very long period of time during which the seal 17, as a whole, remains tight even though the inner seal ring 24 is already leaking.

So that this condition can be detected promptly, it is further provided according to the invention that a surface region located between the two thrust surfaces 35 and bounding the chamber 36 comprises at least one opening 37 to a conduit 38 through which the interior of the chamber 36 is accessible. This conduit 38 can, for example, open to the outside and be sealable, for example, by means of a plug. During maintenance, the plug can be removed and the thus-obtained access to the chamber 36 can be utilized to determine whether the inner seal ring 24 is already leaking, hence whether or not countermeasures are necessary. The possibility also exists of routing the conduit 38—or a branch thereof—to the inner region of the gap 7 and having it open thereinto, so lubricant can be routed from the chamber 36 back to the gap interior 7, for example, under the effect of gravity. To prevent lubricant from escaping through such a conduit 38 in the opposite direction, from the gap 7 into the chamber 36, the conduit 38 can, for example, be fitted with a check valve that closes when there is an overpressure from the gap interior 7 to the chamber 36 and opens only under reverse pressure conditions.

It can also be seen in FIG. 2 that a portion 39 of outer ring 3 comprising the depression 21 is separate from its main or middle portion 40 comprising the nose-shaped flange 8. The separation surface is constituted by a parting plane 41 extending parallel to the main plane of the bearing and having a fully circumferential step 42 that serves as a centering aid during assembly.

Further to be observed in the drawing is that the ring portion 39 that contains the depression 21 and is detachable from the main or middle portion 40 of the particular ring—here, outer ring 3—is provided with coronally distributed bores 44 penetrating the ring 39 in the direction parallel to the axis of rotation of the bearing. Fastening screws can be passed through these coronally distributed bores 44 to secure the particular ring 2, 3 to a machine, installation part, chassis, foundation, or the like. The respective planar connection surface of rings 2, 3 is formed by the same free end face 45 of detachable ring portion 39 that is penetrated by the bores 44. To allow the fastening screws to pass through, the axis-parallel bores 44 in detachable ring portion 39 are each aligned with a respective bore 6 in the main or middle portion 40 of the particular ring 2, 3.

The depression 21, and thus the seal rings 24, 25 received therein, are disposed in the radial direction between the bores 44 in detachable ring portion 39 that are aligned with the bores 6, and the bores 6 in that cylindrical surface region 35 of the other ring—here, inner ring 2—which serves as a thrust surface.

Not illustrated is the possibility of disposing an additional dust seal at the outer seal ring 25, particularly in the region of incut 31 there, to prevent the ingress of dust or other particles into the region of the seal 17. A similar effect is produced by a third, external seal 43, which is anchored in the inner side 20 of outer ring 3 outside of second seal ring 25, and extends in part over the front face, or connection surface 4, of inner ring 2 and there seals as dust-tightly as possible.

1. A sealing assembly (17) for a rolling bearing (1), comprising two mutually concentric rings (2, 3) that are spaced apart from each other by a fully circumferential gap (7) in which one or more rows of circulating rolling elements (13) are disposed, such that the two rings (2, 3) are rotatable relative to each other about their common axis, and wherein the gap (7) is sealed in the region of at least one of its two mouths (18), characterized in that provided in the region of a gap seal (17) are at least two mutually separated seal rings (24, 25), each comprising at least one sealing lip (29) and an anchoring portion (27) on a surface region of the particular seal ring (24, 25) that faces away from the sealing lip (29), wherein the seal rings (24, 25) are fixed by their anchoring portions (27) to a common portion of the same rolling bearing ring (2, 3), while their sealing lips (29) each bear against the other rolling bearing ring (3, 2), specifically against thrust surfaces (35) produced together with at least one raceway of the particular rolling bearing ring (2, 3) by machining or shaping a common base body, wherein the cross-sectional shapes of the thrust surfaces (35) for the sealing lips (29) of at least two adjacent seal rings (24, 25) are identical or similar and are not separated from each other by a bend or a step.

2. The sealing assembly as in claim 1, characterized in that the anchoring portions (27) of two adjacent seal rings (24, 25) are received in a common depression (21) of a rolling bearing ring (2, 3), particularly in a groove or recess.

3. The sealing assembly as in claim 2, characterized in that a receiving portion (39) that is part of a rolling bearing ring (2, 3) and contains a common depression (21), particularly a groove or recess, is detachable from the main portion (40) of the particular rolling bearing ring (2, 3).

4. The sealing assembly as in claim 3, characterized in that the common depression (21), particularly groove or recess, is disposed on an annular receiving portion (39) which itself has no raceway of any kind, but is fixed to an annular main portion (40) that is part of the particular rolling bearing ring and does have at least one raceway produced by machining or shaping a common base body.

5. The sealing assembly as in one of claim 3 or 4, characterized in that the receiving portion (39) detachable from the main portion (40) of a rolling bearing ring (2, 3) consists of a different and/or a differently treated material from the main portion (40) of that rolling bearing ring (2, 3).

6. The sealing assembly as in one of claims 3 to 5, characterized in that the receiving portion (39) detachable from the main portion (40) of a rolling bearing ring (2, 3) has an approximately L-shaped cross section whose end face facing toward the rolling elements (13) has a smaller area than its end face facing away from the rolling elements (13).

7. The sealing assembly as in claim 6, characterized in that the receiving portion (39) detachable from the main portion (40) of a rolling bearing ring (2, 3) has, in the region of its end face facing away from the rolling elements, a circular-disk-shaped portion that overlaps the end face of one seal ring (24, 25).

8. The sealing assembly as in one of claims 2 to 7, characterized in that two adjacent seal rings (24, 25) are separated from each other, within the common depression (21) of the receiving portion (39), by one or more spacers (26).

9. The sealing assembly as in claim 8, characterized in that at least one spacer (26) is configured as a ring or ring segment.

10. The sealing assembly as in one of the preceding claims, characterized in that the sealing lips (29) of adjacent seal rings (24, 25) bear against the same rolling bearing ring (2, 3) in mutual spaced relation.

11. The sealing assembly as in one of claims 8 to 10, characterized in that at least one conduit (38), preferably a bore, opens (37) between two adjacent seal rings (24, 25) into the common depression (21) or between the two thrust surfaces (35) for the sealing lips (29).

12. The sealing assembly as in one of the preceding claims, characterized in that one, preferably two adjacent, seal rings (24, 25) of a common gap seal (17) are both integrated in such a way that an internal overpressure from its end face (their respective end faces) facing the rolling elements (13) presses the sealing lips (29) additionally against the particular thrust surface (35).

13. The sealing assembly as in claim 12, characterized in that at least one, preferably at least two, seal rings (24, 25) of a common gap seal (17) comprise(s) in its (their respective) cross section(s) a respective receiving pocket that opens in the direction of the rolling elements (13).

14. The sealing assembly as in one of claim 12 or 13, characterized in that the sealing lip (29) of a seal ring (24, 25) is disposed at the free edge of an approximately collar-shaped and/or conical portion (28) of the seal ring (24, 25).

15. The sealing assembly as in claim 14, characterized in that a seal ring (24, 25) is integrated in such a way that the collar-like portion (28) of the seal ring (24, 25) does not extend in cross section perpendicular to the particular thrust surface (35), but extends in closer proximity to the outer, unsealed region of the thrust surface (35).

16. The sealing assembly as in one of claim 14 or 15, characterized in that the collar-like portion (28) of a seal ring (24, 25) is connected to its anchoring portion (27), specifically in the region of that end face (34) of said anchoring portion (27) which is disposed outside the sealed gap region (7).

17. The sealing assembly as in one of the preceding claims, characterized in that at least one, preferably at least two, seal ring(s) (24, 25) of a common gap seal (17) both comprise(s) a tensioning means, for example a fully circumferential tension wire or a fully circumferential tension spring, in order to press the particular sealing lip (29) firmly against the particular thrust surface (35).

18. The sealing assembly as in claim 17, characterized in that a fully circumferential tension wire or a fully circumferential tension spring has a length that is equal to or greater than the diameter of a rolling element (13), multiplied by the number of rolling elements (13) in the particular row.

19. The sealing assembly as in one of the preceding claims, characterized in that two adjacent seal rings (24, 25) of a common gap seal (17) have the same cross section, in particular are identical.

20. The sealing assembly as in claim 19, characterized in that the cross-sectional shapes of the thrust surfaces (35) for the sealing lips (29) of adjacent seal rings (24, 25) have the same axial inclination, particularly are in mutual axial alignment.

21. The sealing assembly as in one of claim 19 or 20, characterized in that the sealing lips (29) of two adjacent seal rings (24, 25) bear or thrust against a common cylindrical surface region (35) having a constant diameter.

22. The sealing assembly as in one of the preceding claims, characterized in that the outermost seal (25) of a plurality of seals (24, 25) of a common gap seal (17) is provided with a dust lip.
